(19) United States
(12) Patent Application Publication
(10) Pub. No.: US 2024/0048483 A1
(43) Pub. Date: Feb. 8, 2024

(54) PCE for BIER-TE Ingress Protection

(71) Applicant: Huawei Technologies Co., Ltd., Shenzhen (CN)

(72) Inventor: Huaimo Chen, Bolton, MA (US)

(21) Appl. No.: 18/487,888

(22) Filed: Oct. 16, 2023

Related U.S. Application Data
(63) Continuation of application No. PCT/US2022/017986, filed on Feb. 25, 2022.
(60) Provisional application No. 63/178,343, filed on Apr. 22, 2021.

(51) Int. Cl. H04L 45/741; H04L 45/00; H04L 45/52

(52) U.S. Cl. CPC H04L 45/741; H04L 45/72; H04L 45/52

(57) ABSTRACT

A method implemented by a path computation element (PCE) configured to control a Bit Index Explicit Replication Traffic/Tree Engineering (BIER-TE) domain. The method includes sending a first path computation element protocol (PCEP) message to a network node in the BIER-TE domain. The first PCEP message includes a first path setup type capability type length value (TLV). The method further includes receiving a second PCEP message from the network node. The second PCEP message includes a second path setup type capability TLV comprising an ingress protection capability sub-TLV. The ingress protection capability sub-TLV contains a first flag. The first flag is set to a first binary value to indicate that the network node is able to detect a failure of an adjacent network node.

### CROSS-REFERENCE TO RELATED APPLICATIONS

This patent application is a continuation of International Application No. PCT/US2022/017986 filed on Feb. 25, 2022, which claims the benefit of U.S. Provisional Patent Application No. 63/178,343 filed Apr. 22, 2021, each of which is hereby incorporated by reference.

### TECHNICAL FIELD

The present disclosure is generally related to the field of network communication and, in particular, to a path computation element (PCE) configured to set up ingress protection for Bit Index Explicit Replication-Traffic/Tree Engineering (BIER-TE) domain.

### BACKGROUND

BIER mechanisms provide optimized forwarding of multicast data packets through a BIER domain. BIER domains may not require the use of a protocol for explicitly building multicast distribution trees. Further, BIER domains may not require intermediate nodes to maintain any per-flow state. BIER is described in further detail in Internet Engineering Task Force (IETF) document Request for Comments (RFC) 8279 entitled “Multicast Using Bit Index Explicit Replication (BIER)” by I J. Wijnands, et al., published November 2017.

Traffic Engineering (TE) is the process of steering traffic across to a telecommunications network to facilitate efficient use of available bandwidth between a pair of routers. Bit Index Explicit Replication (BIER) Traffic/Tree Engineering (BIER-TE) is described in IETF document “Tree Engineering for Bit Index Explicit Replication (BIER-TE)” by T. Eckert, et al., published Jul. 9, 2021.

### SUMMARY

The disclosed aspects/embodiments provide techniques that allow a path computation element (PCE) to set up ingress protection for a Bit Index Explicit Replication Traffic/Tree Engineering (BIER-TE) domain. In order to facilitate the techniques, the present disclosure provides extensions to type length values (TLVs) and sub-TLVs and a new path computation element protocol (PCEP) object, each of which are carried in PCEP messages. Using the extensions and/or the new PCEP object, packet routing within the BIER-TE domain is improved relative to existing techniques.

A first aspect relates to a method implemented by a first path computation element (PCE) configured to control a Bit Index Explicit Replication Traffic/Tree Engineering (BIER-TE) domain, comprising: sending a first path computation element protocol (PCEP) message to a network node in the BIER-TE domain, wherein the first PCEP message includes a first path setup type capability type length value (TLV); and receiving a second PCEP message from the network node, wherein the second PCEP message includes a second path setup type capability TLV comprising an ingress protection capability sub-TLV, wherein the ingress protection capability sub-TLV contains a first flag, and wherein the first flag is set to a first binary value to indicate that the network node is able to detect a failure of an adjacent network node.

Optionally, in any of the preceding aspects, another implementation of the aspect provides that the first PCEP message is an open message, and wherein the first path setup type capability TLV includes a first central controller (PCECC) sub-type length value (sub-TLV) containing a second flag, and wherein the second flag is set to the first binary value to indicate that the PCE supports and is willing to handle PCECC-based central controller instructions for ingress protection.

Optionally, in any of the preceding aspects, another implementation of the aspect provides that the first path setup type capability TLV includes a path setup type (PST) containing a first value that indicates the path setup type capability TLV is for a BIER-TE path.

Optionally, in any of the preceding aspects, another implementation of the aspect provides that the network node comprises a backup ingress node in the BIER-TE domain or a customer edge (CE), and wherein the second PCEP message is an open message, and wherein the second path setup type capability TLV contains the first value.

Optionally, in any of the preceding aspects, another implementation of the aspect provides that the second path setup type capability TLV contains a second central controller (PCECC) sub-type length value (sub-TLV) including a third flag, and wherein the third flag is set to the first binary value to indicate that the network node supports and is willing to handle PCECC-based central controller instructions for ingress protection.

Optionally, in any of the preceding aspects, another implementation of the aspect provides determining that the network node will be responsible for detecting the failure of the adjacent network node based on the first binary value of the first flag in the second PCEP message from the network node.

Optionally, in any of the preceding aspects, another implementation of the aspect provides that the network node comprises a backup ingress node in the BIER-TE domain, and wherein the method further comprises sending a third PCEP message to the backup ingress node, wherein the third PCEP message includes an ingress protection TLV containing: a fourth flag set to the first binary value to request that a forwarding entry for a backup BIER-TE path be active always; and a service sub-TLV including a service label or a service identifier.

Optionally, in any of the preceding aspects, another implementation of the aspect provides that the network node comprises a backup ingress node in the BIER-TE domain, and wherein the method further comprises sending a third PCEP message to the backup ingress node, wherein the third PCEP message includes an ingress protection TLV containing: a fourth flag set to a second binary value to request that the backup ingress node detect the failure of a primary ingress node and to let a forwarding entry for a backup BIER-TE path be active when the primary ingress node fails; a service sub-TLV including a service label or a service identifier; and a primary ingress sub-TLV including a primary ingress address.

Optionally, in any of the preceding aspects, another implementation of the aspect provides that the network node comprises a customer edge (CE), and wherein the method further comprises sending a fourth PCEP message to the CE, wherein the fourth PCEP message includes an ingress protection object body containing a fifth flag and a sixth flag, wherein the fifth flag is set to the first binary value to instruct the CE to detect the failure of a primary ingress node and to switch traffic to a backup ingress node when the CE detects the failure, and wherein the sixth flag is set to a second binary value.

A second aspect relates to a path computation element (PCE) configured to control a Bit Index Explicit Replication Traffic/Tree Engineering (BIER-TE) domain, comprising: a memory storing instructions; one or more processors coupled to the memory, wherein the one or more processors are configured to execute the instructions to cause the PCE to: send a first path computation element protocol (PCEP) message to a network node in the BIER-TE domain, wherein the first PCEP message includes a first path setup type capability type length value (TLV); and receive a second PCEP message from the network node, wherein the second PCEP message includes a second path setup type capability TLV comprising an ingress protection capability sub-TLV, wherein the ingress protection capability sub-TLV contains a first flag, and wherein the first flag is set to a first binary value to indicate that the network node is able to detect a failure of an adjacent network node.

Optionally, in any of the preceding aspects, another implementation of the aspect provides that the first PCEP message is an open message, wherein the first path setup type capability TLV of the open message includes a path setup type (PST) containing a first value that indicates the path setup type capability TLV is for a BIER-TE path.

Optionally, in any of the preceding aspects, another implementation of the aspect provides that the first path setup type capability TLV includes a first central controller (PCECC) sub-type length value (sub-TLV) containing a second flag, and wherein the second flag is set to the first binary value to indicate that the PCE supports and is willing to handle PCECC-based central controller instructions for ingress protection.

Optionally, in any of the preceding aspects, another implementation of the aspect provides that the network node comprises a backup ingress node in the BIER-TE domain or a customer edge (CE), and wherein the second PCEP message is an open message, and wherein the second path setup type capability TLV contains the first value.

Optionally, in any of the preceding aspects, another implementation of the aspect provides that the second path setup type capability TLV contains a second central controller (PCECC) sub-type length value (sub-TLV) including a third flag, and wherein the third flag is set to the first binary value to indicate that the network node supports and is willing to handle PCECC-based central controller instructions for ingress protection.

Optionally, in any of the preceding aspects, another implementation of the aspect provides that the one or more processors are further configured to determine that the network node will be responsible for detecting the failure of the adjacent network node based on the first binary value of the first flag in the second PCEP message from the network node.

Optionally, in any of the preceding aspects, another implementation of the aspect provides that the network node comprises a backup ingress node, and wherein the one or more processors are further configured to send a third PCEP message to the backup ingress node, wherein the third PCEP message includes an ingress protection TLV containing: a fourth flag set to the first binary value to request that a forwarding entry for a backup BIER-TE path be active always; and a service sub-TLV including a service label or a service identifier.

Optionally, in any of the preceding aspects, another implementation of the aspect provides that the network node comprises a backup ingress node, and wherein the one or more processors are further configured to send a third PCEP message to the backup ingress node, wherein the third PCEP message includes an ingress protection TLV containing: a fourth flag set to a second binary value to request that the backup ingress node detect the failure of a primary ingress node and to let a forwarding entry for a backup BIER-TE path be active when the primary ingress node fails; a service sub-TLV including a service label or a service identifier; and a primary ingress sub-TLV including a primary ingress address.

Optionally, in any of the preceding aspects, another implementation of the aspect provides that the network node comprises a customer edge (CE), and wherein the one or more processors are further configured to send a fourth PCEP message to the CE, wherein the fourth PCEP message includes an ingress protection object body containing a fifth flag and a sixth flag, wherein the fifth flag is set to the first binary value to instruct the CE to detect the failure of a primary ingress node and to switch traffic to a backup ingress node when the CE detects the failure, and wherein the sixth flag is set to a second binary value.

Optionally, in any of the preceding aspects, another implementation of the aspect provides that the network node comprises a customer edge (CE), and wherein the one or more processors are further configured to send a fourth PCEP message to the CE, wherein the fourth PCEP message includes an ingress protection object body containing a fifth flag and a sixth flag, wherein the fifth flag is set to a second binary value, and wherein the sixth flag is set to the first binary value to instruct the CE to send traffic to both a primary ingress node and a backup ingress node.

A third aspect relates to a non-transitory computer readable medium comprising a computer program product for use by a network node, the computer program product comprising computer executable instructions stored on the non-transitory computer readable medium that, when executed by one or more processors, cause the network node to: send a first path computation element protocol (PCEP) message to a network node in the BIER-TE domain, wherein the first PCEP message includes a first path setup type capability type length value (TLV); and receive a second PCEP message from the network node, wherein the second PCEP message includes a second path setup type capability TLV comprising an ingress protection capability sub-TLV, wherein the ingress protection capability sub-TLV contains a first flag, and wherein the first flag is set to a first binary value to indicate that the network node is able to detect a failure of an adjacent network node.

Optionally, in any of the preceding aspects, another implementation of the aspect provides that the instructions further cause the network node to determine that the network node will be responsible for detecting the failure of the adjacent network node based on the first binary value of the first flag in the second PCEP message from the network node.

Optionally, in any of the preceding aspects, another implementation of the aspect provides that the network node comprises a backup ingress node, and wherein the instructions further cause the network node to send a third PCEP message to the backup ingress node, wherein the third PCEP message includes an ingress protection TLV containing: a fourth flag set to the first binary value to request that a forwarding entry for a backup BIER-TE path be active always; and a service sub-TLV including a service label or a service identifier.

Optionally, in any of the preceding aspects, another implementation of the aspect provides that the network node comprises a backup ingress node, and wherein the instructions further cause the network node to send a third PCEP message to the backup ingress node, wherein the third PCEP message includes an ingress protection TLV containing: a fourth flag set to a second binary value to request that the backup ingress node detect the failure of a primary ingress node and to let a forwarding entry for a backup BIER-TE path be active when the primary ingress node fails; a service sub-TLV including a service label or a service identifier; and a primary ingress sub-TLV including a primary ingress address.

Optionally, in any of the preceding aspects, another implementation of the aspect provides that the network node comprises a customer edge (CE), and wherein the instructions further cause the network node to send a fourth PCEP message to the CE, wherein the fourth PCEP message includes an ingress protection object body containing a fifth flag and a sixth flag, wherein the fifth flag is set to the first binary value to instruct the CE to detect the failure of a primary ingress node and to switch traffic to a backup ingress node when the CE detects the failure, and wherein the sixth flag is set to a second binary value.

Optionally, in any of the preceding aspects, another implementation of the aspect provides that the network node includes a customer edge (CE), and wherein the instructions further cause the network node to send a fourth PCEP message to the CE, wherein the fourth PCEP message includes an ingress protection object body containing a fifth flag and a sixth flag, wherein the fifth flag is set to a second binary value, and wherein the sixth flag is set to the first binary value to instruct the CE to send traffic to both a primary ingress node and a backup ingress node.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a BIER-TE topology including a BIER-TE domain.

FIG. 2 is a schematic diagram of a BIER-TE-Path_Ingress_Protection_Capability sub-type length value (sub-TLV) according to an embodiment of the disclosure.

FIG. 3 is a schematic diagram of a Path Computation Element (PCE) for a Central Controller (PCECC) Capability TLV according to an embodiment of the disclosure.

FIG. 4 is a schematic diagram of a BIER-TE-Path_Ingress_Protection TLV according to an embodiment of the disclosure.

FIG. 5 is a schematic diagram of a Primary Ingress Internet Protocol version 4 (IPv4) Address sub-TLV according to an embodiment of the disclosure.

FIG. 6 is a schematic diagram of a Primary Ingress Internet Protocol version 6 (IPv6) Address sub-TLV according to an embodiment of the disclosure.

FIG. 7 is a schematic diagram of a Service Label sub-TLV according to an embodiment of the disclosure.

FIG. 8 is a schematic diagram of a Service Identifier (ID) sub-TLV according to an embodiment of the disclosure.

FIG. 9 is a schematic diagram of a BIER-TE-Path_Ingress-Protection Object Body according to an embodiment of the disclosure.

FIG. 10 is a schematic diagram of a Backup Ingress IPv4 Address TLV according to an embodiment of the disclosure.

FIG. 11 is a schematic diagram of a Backup Ingress IPv6 Address TLV according to an embodiment of the disclosure.

FIG. 12 is a method implemented by a network controller configured to control the BIER-TE domain according to an embodiment of the disclosure.

FIG. 13 is a schematic diagram of a network apparatus according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Existing techniques for fast protection for a BIER-TE path (a.k.a., a point to multipoint (P2MP) path, a BIER-TE P2MP path, a BIER-TE tunnel, or variations thereof) have drawbacks. For example, existing solutions are limited to protecting the transit nodes and links of the BIER-TE path and, as such, are unable to provide fast protection for the ingress node. Because the ingress node adds the bit positions for the BIER-TE path into the header of every packet to be transported along the BIER-TE path, the ingress node is critical.

Disclosed herein are techniques that allow a path computation element (PCE) to set up ingress protection for a Bit Index Explicit Replication Traffic/Tree Engineering (BIER-TE) domain. In order to facilitate the techniques, the present disclosure provides extensions to type length values (TLVs) and sub-TLVs and a new path computation element protocol (PCEP) object, each of which are carried in PCEP messages. Using the extensions and/or the new PCEP object, packet routing within the BIER-TE domain is improved relative to existing techniques.

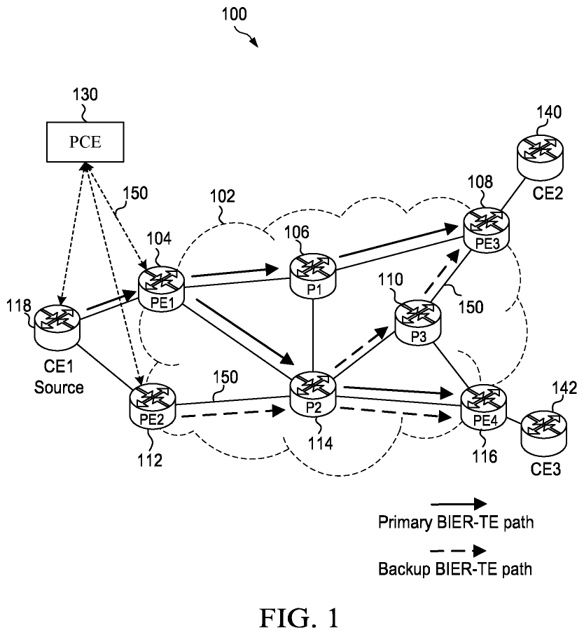

FIG. 1 is a schematic diagram of a BIER-TE topology 100 including a BIER-TE domain 102. The BIER-TE domain 102 may be part of a larger BIER-TE domain (not shown). As such, the BIER-TE domain 102 may be referred to herein as a BIER-TE sub-domain. The BIER-TE domain 102 comprises a plurality of network nodes 104, 106, 108, 110, 112, 114, and 116. While seven network nodes 104-116 are shown in the BIER-TE domain 102, more or fewer nodes may be included in practical applications.

Each of the network nodes 104-116 is a bit forwarding router (BFR). Some of the network nodes, namely the network nodes 104, 108, 112 and 116, are disposed at an edge of the BIER-TE domain 102. The network nodes 104, 108, 112 and 116 receiving multicast packets from outside the BIER-TE domain 102 may be referred to as an ingress BFR (BFIR). The network nodes 104, 108, 112 and 116 transmitting multicast packets out of the BIER-TE domain 102 may be referred to as an egress BFR (BFER). Depending on the direction of multicast packet traffic, each of the network nodes 104, 108, 112 and 116 may function as a BFIR or a BFER.

The network nodes 104 and 112 are in communication with a network node referred to as a first customer edge (CE1) 118. In the illustrated embodiment, the CE1 118 is a source. The source (e.g., a server, a data center, etc.) is configured to store information or data (e.g., media files, web pages, etc.) and deliver such information or data to a consumer upon request. The network node 108 is in communication with a second customer edge (CE2) 140 and the network node 116 is in communication with a third customer edge (CE3) 142. As such, packets received from the CE1 and routed through the BIER-TE domain 102 may eventually be delivered to the CE2 140 and/or the CE3 142 for consumption by the consumer.

Each of the network nodes 104-116 has one or more neighbor nodes. As used herein, a neighbor node refers to a network node that is only one hop away from the network node. For example, network node 106 has three neighbor nodes in FIG. 1, namely network node 104, network node 108, and network node 114. Indeed, each of network node 104, network node 108, and network node 114 is only one hop away from network node 106.

The network nodes 104-116 in FIG. 1 are coupled to, and communicate with each other, via links 150. The links 150 may be wired, wireless, or some combination thereof. In an embodiment, each of the links 150 may have a cost. The cost of each of the links 150 may be the same or different, depending on the BIER-TE network and conditions therein.

The BIER domain 102 is controlled by a network controller 130. In an embodiment, the network controller 130 is a path computation element (PCE). A PCE is a system component, application, or network node capable of determining and finding a suitable route for conveying data (e.g., packets) through a network between a source and a destination. In order to control the BIER-TE domain 102, in one embodiment, the network controller 130 is in communication with each of the network nodes therein, namely network nodes 104-116. That is, the network controller 130 is able to exchange messages with the network nodes 104-116. In another embodiment, the network controller 130 is in communication with each of the network edge nodes (i.e., BFIRs or BFERs) therein, namely network nodes 104, 108, 112 and 116. That is, the network controller 130 is able to exchange messages with the network nodes 104, 108, 112 and 116.

In an embodiment, a path computation client (PCC) is running on one or more of the network nodes 104-116, CE1 118, CE2 140, and/or CE3 142. A PCC is a client application or component configured to request that the PCE perform a path computation. For example, the PCC may request that the PCE calculate a BIER-TE path.

In the illustrated embodiment of FIG. 1, a primary BIER-TE path (as shown by bold arrows) extends from network node 104, which is the primary ingress node, to network node 108 and network node 116, which are the egress nodes. A backup BIER-TE path (as shown by bold dashed arrows) extends from network node 112, which is the backup ingress node, to network node 108 and network node 116, which are the egress nodes. The primary BIER-TE path and the backup BIER-TE path are each configured to transport traffic (e.g., multicast packets) from the CE1 118.

In normal operations, the CE1 118 sends multicast packets to network node 104, which is the primary ingress node. The network node 104 encapsulates the packets with a BIER-TE header, which includes an encoding of the primary BIER-TE path from the network node 104 to network node 108 and to network node 116. In an embodiment, the BIER-TE header includes bit positions for forward connected adjacencies.

When network node 104 fails, the CE1 118 sends multicast packets to the network node 112, which is the backup ingress node. The network node 112 encapsulates the packets with a BIER-TE header, which includes an encoding of the backup BIER-TE path from the network node 112 to network node 108 and to network node 116. In an embodiment, the BIER-TE header includes bit positions for forward connected adjacencies.

To support BIER-TE ingress protection, the network controller 130 sends information to network node 112. Such information includes, for example, the backup BIER-TE path and other information (e.g., the backup BIER-TE path, an address of a primary ingress node, a description of the multicast traffic, the service, etc.) as will be discussed in detail herein.

Using the embodiment of FIG. 1 as an example, three different cases involving the failure of the network node 104 are considered. In a first case, the CE1 118 is responsible for detecting the failure of the network node 104. Before any failure is detected, the CE1 118 sends multicast packets to the network node 104. In this embodiment, the network node 112, which is the backup ingress node, is ready to encapsulate packets with the backup BIER-TE path. After the CE1 118 detects the failure of the network node 104, the CE1 118 sends multicast packets to the network node 112. The network node 112 then encapsulates the packets with the BIER-TE path since the network node 112 is ready.

In a second case, the network node 112 is responsible for detecting the failure of the network node 104. Before any failure is detected, the CE1 118 sends multicast packets to both the network node 104 and the network node 112. In this embodiment, the network node 112 drops the packets. After the network node 112 detects the failure of the network node 104, the CE1 118 sends multicast packets to the network node 112. The network node 112 then encapsulates the packets with the BIER-TE path since the network node 112 is ready.

In a third case, the CE1 118 and the network node 112 are both responsible for detecting the failure of the network node 104. Before any failure is detected, the CE1 118 sends multicast packets to the network node 104. After the CE1 118 and/or the network node 112 detects the failure of the network node 104, the CE1 118 sends multicast packets to the network node 112. The network node 112 then encapsulates the packets with the BIER-TE path since the network node 112 is ready.

In order to implement the three different cases, the network controller 130 sends the PCC operating on the network node 112 the backup BIER-TE path, the address of the primary ingress, a description of the traffic carried by the BIER-TE path, and a service label or service ID carried by the BIER-TE path. The network controller 130 also sends the PCC operating on the CE1 118 instructions for implementing the three cases noted above. The network controller 130 is able to send this information using one or more TLVs, sub-TLVs, and/or object bodies, as discussed further below.

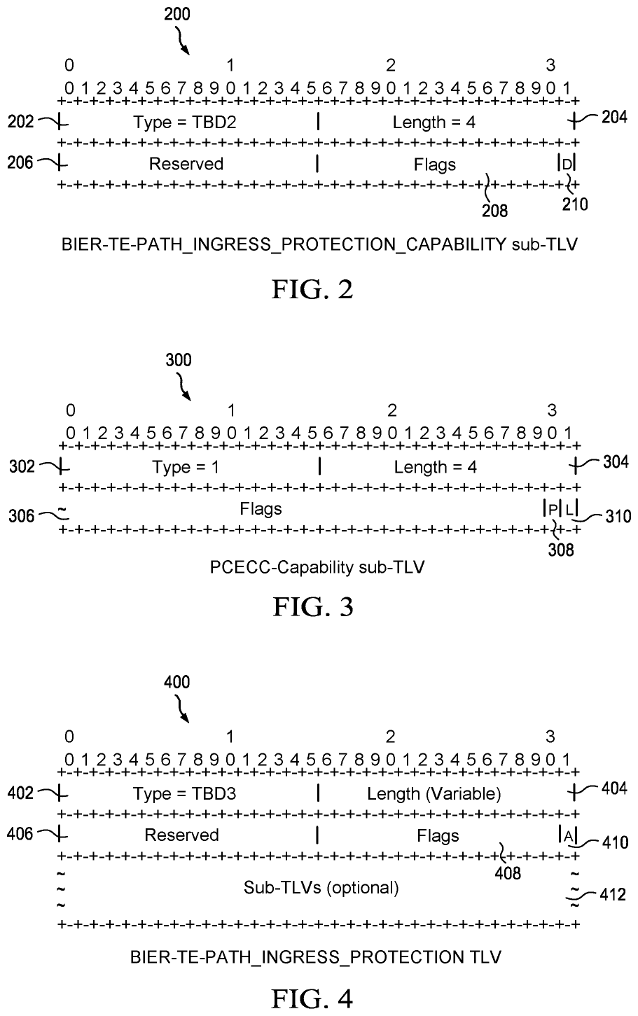

FIG. 2 is a schematic diagram of a BIER-TE-Path_Ingress_Protection_Capability sub-TLV 200 according to an embodiment of the disclosure. In an embodiment, the BIER-TE-Path_Ingress_Protection_Capability sub-TLV 200 is included in a Path_Setup_Type_Capability TLV of an open message. In an embodiment, the Path_Setup_Type_Capability TLV includes a path setup type (PST) field with a value to be assigned by the Internet Assigned Numbers Authority (IANA). In an embodiment, the value indicates that the path is a BIER-TE path (e.g., the backup BIER-TE path).

The BIER-TE-Path_Ingress_Protection_Capability sub-TLV 200 comprises a type field 202, a length field 204, a reserved field 206, and a flags field 208. The type field 202 is 16 bits and the value in the type field 202 is to be assigned by the IANA. The length field 204 is 16 bits. In an embodiment, the value in the length field 204 is 4 to indicate that 4 bytes is the total length of the remainder of the sub-TLV, excluding the type and length fields 202, 204. The reserved field 206 is 16 bits. In an embodiment, the reserved field 206 is set to zero by the sender of the BIER-TE-Path_Ingress_Protection_Capability sub-TLV 200 and ignored by the receiver of the BIER-TE-Path_Ingress_Protection_Capability sub-TLV 200.

The flags field 208 includes one or more flags, such as the D flag 210. The D flag 210 is set to a first binary value (e.g., 1) to indicate that the network node is able to quickly detect a failure of the network node adjacent to the network node. The D flag 210 is also set to a second binary value (e.g., 0) when the network node is unable to quickly detect the failure of the network node adjacent to the network node. For example, when the network node 112 is able to quickly detect the failure of the network node 104, the D flag 210 is set to a value of 1.

FIG. 3 is a schematic diagram of a Path Computation Element (PCE) for a Central Controller (PCECC) Capability sub-TLV 300 according to an embodiment of the disclosure. In an embodiment, the PCECC Capability sub-TLV 300 is included in a Path_Setup_Type_Capability TLV of an open message.

The PCECC Capability sub-TLV 300 comprises a type field 302, a length field 304, and a flags field 306. The type field 302 is 16 bits and the value in the type field 302 is set to one to indicate that the sub-TLV 300 is a PCECC Capability sub-TLV and the length of the PCECC Capability sub-TLV 300 is 4 octets. The length field 204 is 16 bits. In an embodiment, the value in the length field 204 is 4 to indicate that flags field 306 is 32 bits.

The flags field 306 includes one or more flags, such as the P flag 308 and the L flag 310. The P flag 308 (for ingress protection) is set to a first binary value (e.g., 1) to indicate that the PCEP speaker supports and is willing to handle the PCECC instructions for ingress protection. The bit is set to 1 by both a PCC and a PCE for the PCECC ingress protection instruction download/report on a PCEP session.

The L flag 310 is set to a first binary value (e.g., 1) to indicate that the PCEP speaker will support and is willing to handle the PCECC instructions for label download. The bit is set to 1 by both a PCC and a PCE for the PCECC label download/report on a PCEP session.

FIG. 4 is a schematic diagram of a BIER-TE-Path_Ingress_Protection TLV 400 according to an embodiment of the disclosure. In an embodiment, the BIER-TE-Path_Ingress_Protection TLV 400 is included in a path computation label switched path (LSP) initiate request (PCInitiate) message.

The BIER-TE-Path_Ingress_Protection TLV 400 comprises a type field 402, a length field 404, a reserved field 406, a flags field 408, and a sub-TLVs field 412. The type field 402 is 16 bits and the value in the type field 402 is to be assigned by the IANA. The length field 404 is 16 bits. The value of the length field 404 is variable. In an embodiment, the value in the length field 404 is set to indicate the total length of the remainder of the TLV, excluding the type and length fields 402, 404.

The reserved field 406 is 16 bits. In an embodiment, the reserved field 406 is set to zero by the sender of the BIER-TE-Path_Ingress_Protection TLV 400 and ignored by the receiver of the BIER-TE-Path_Ingress_Protection TLV 400. The flags field 406 includes one or more flags, such as the A flag 410. The A flag 410 is set to a first binary value (e.g., 1) to request a PCC to let the forwarding entry for the backup BIER-TE path be active always. When the network node on which the PCC is running receives the PCECC Capability sub-TLV 300 with the P flag bit 308 set to 1, the network node sets the forwarding entry for the backup BIER-TE path in the forwarding table to 1. Once the forwarding entry is set, the network node is ready to use or uses the backup BIER-TE path to forward multicast packet traffic. The sub-TLVs field 412 is configured to carry any optional sub-TLVs.

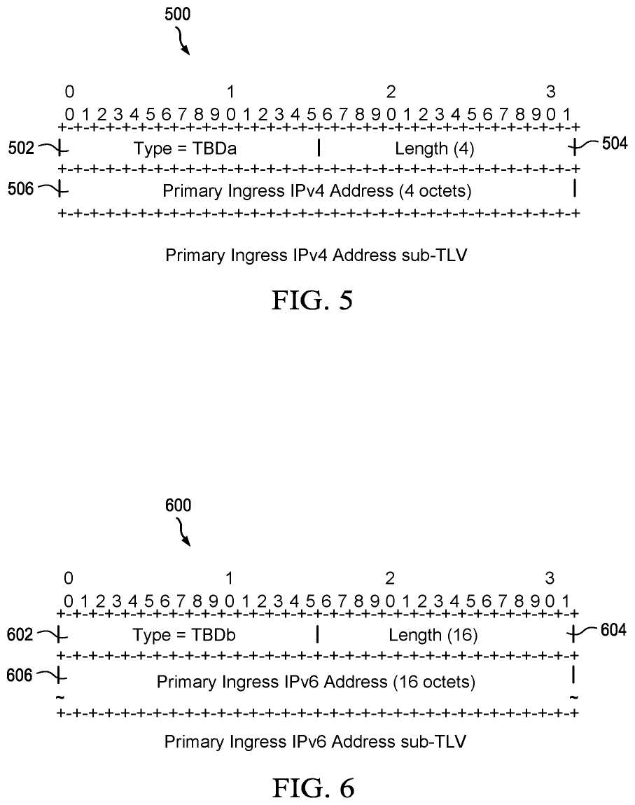

FIG. 5 is a schematic diagram of a Primary Ingress Internet Protocol version 4 (IPv4) Address sub-TLV 500 according to an embodiment of the disclosure. In an embodiment, the Primary Ingress IPv4 Address sub-TLV 500 is carried in the sub-TLVs field 412 of the BIER-TE-Path_Ingress_Protection TLV 400.

The Primary Ingress IPv4 Address sub-TLV 500 comprises a type field 502, a length field 504, and a primary ingress IPv4 Address field 506. The type field 502 is 16 bits and the value in the type field 502 is to be assigned by the IANA. The length field 504 is 16 bits. In an embodiment, the value in the length field 504 is 4 to indicate that the primary ingress IPv4 Address field 506 is 32 bits. The primary ingress IPv4 Address field 506 contains the address of the primary ingress node. For example, the primary ingress IPv4 Address field 506 may include the address of network node 104 in FIG. 1.

FIG. 6 is a schematic diagram of a Primary Ingress Internet Protocol version 6 (IPv6) Address sub-TLV according to an embodiment of the disclosure. In an embodiment, the Primary Ingress IPv6 Address sub-TLV 600 is carried in the sub-TLVs field 412 of the BIER-TE-Path_Ingress_Protection TLV 400.

The Primary Ingress IPv6 Address sub-TLV 600 comprises a type field 602, a length field 604, a primary ingress IPv6 Address field 606. The type field 602 is 16 bits and the value in the type field 602 is to be assigned by the IANA. The length field 604 is 16 bits. In an embodiment, the value in the length field 604 is 16 to indicate that the primary ingress IPv6 Address field 606 is 128 bits. The primary ingress IPv6 Address field 606 contains the IPv6 address of the primary ingress node. For example, the primary ingress IPv6 Address field 606 may include the IPv6 address of network node 104 in FIG. 1.

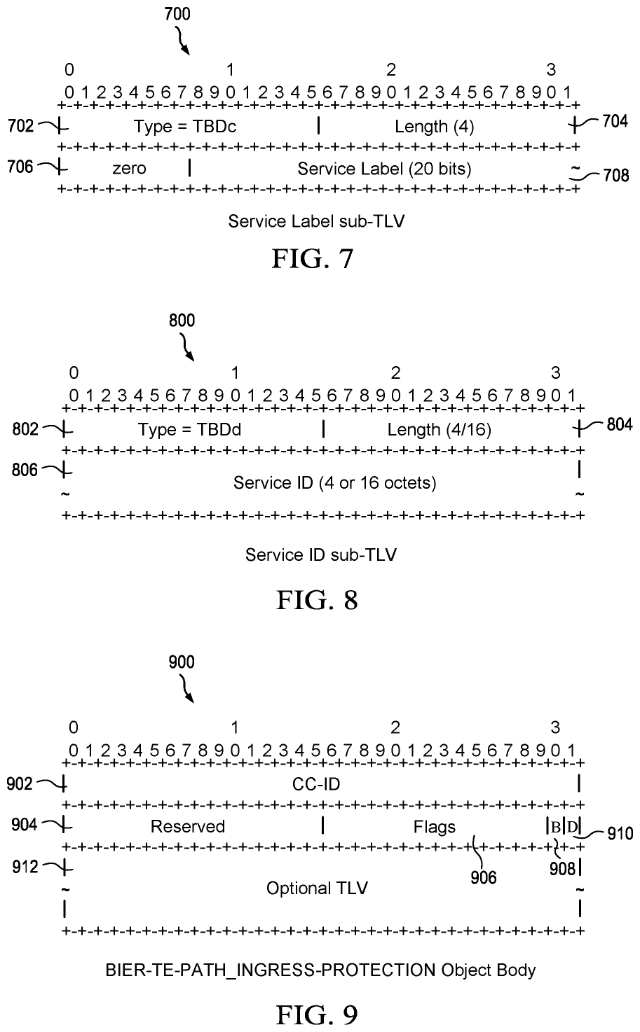

FIG. 7 is a schematic diagram of a Service Label sub-TLV 700 according to an embodiment of the disclosure. In an embodiment, the Service Label sub-TLV 700 is carried in the sub-TLVs field 412 of the BIER-TE-Path_Ingress_Protection TLV 400.

The Service Label sub-TLV 700 comprises a type field 702, a length field 704, a zero field 706, and a service label field 708. The type field 702 is 16 bits and the value in the type field 702 is to be assigned by the IANA. The length field 704 is 16 bits. In an embodiment, the value in the length field 704 is 4 to indicate that 4 bytes is the total length of the remainder of the sub-TLV, excluding the Type and Length fields 702, 704. The zero field 706 is 8 bits. In an embodiment, the zero field 706 is set to zero by the sender of the Service Label sub-TLV 700 and ignored by the receiver of the Service Label sub-TLV 700.

The service label field 708 is 20 bits and includes a value that identifies a service. The service identified by the value in the service label field 708 may be, for example, a virtual private network (VPN). Other types of services may be identified in practical applications.

FIG. 8 is a schematic diagram of a Service Identifier (ID) sub-TLV 800 according to an embodiment of the disclosure. In an embodiment, the Service ID sub-TLV 800 is carried in the sub-TLVs field 412 of the BIER-TE-Path_Ingress_Protection TLV 400.

The Service ID sub-TLV 800 comprises a type field 802, a length field 804, and a service ID field 806. The type field 802 is 16 bits and the value in the type field 802 is to be assigned by the IANA. The length field 804 is 16 bits. In an embodiment, the value in the length field 804 is 4 or 16 to indicate that the service ID field 806 is either 4 bytes or 16 bytes, respectively.

The service ID field 806 is 4 or 16 octets and includes a value (e.g., a service ID) that identifies a service. The service identified by the value in the service ID field 806 may be, for example, a VPN. Other types of services may be identified in practical applications.

FIG. 9 is a schematic diagram of a BIER-TE-Path_Ingress-Protection Object Body 900 according to an embodiment of the disclosure. The BIER-TE-Path_Ingress-Protection Object Body 900 has a new object type (TBDt) for BIER-TE ingress protection and is based on a central controller instructions (CCI) object. The BIER-TE-Path_Ingress-Protection Object Body 900 is used by the PCE (e.g., network controller 130) to specify the forwarding instructions (e.g., label information) to the PCC. In an embodiment, the BIER-TE-Path_Ingress-Protection Object Body 900 is included in a path computation LSP state report (PCRpt) message, a path computation LSP update request (PCUpd) message, or a PCInitiate message.

The BIER-TE-Path_Ingress-Protection Object Body 900 comprises a central controller identifier (CC-ID) field 902, a reserved field 904, a flags field 906, and an optional TLV field 912. The CC-ID field 902 is 32 bits and contains a PCEP-specific identifier for the CCI information. A PCE creates a CC-ID for each instruction. The value in the CC-ID field 902 is unique within the scope of the PCE and is constant for the lifetime of a PCEP session.

The reserved field 904 is 16 bits. In an embodiment, the reserved field 904 is set to zero by the sender of the BIER-TE-Path_Ingress-Protection Object Body 900 and ignored by the receiver of the BIER-TE-Path_Ingress-Protection Object Body 900.

The flags field 906 includes one or more flags, such as the B flag 908 and the D flag 910. The B flag 908 is set to a first binary value (e.g., 1) to instruct the traffic source (e.g., network node 118) to send the traffic to both the primary ingress node (e.g., network node 104) and the backup ingress node (e.g., network node 112). The D flag 910 instructs the traffic source to detect the failure of the primary ingress node and to switch the traffic to the backup ingress when the traffic source detects the failure. The optional TLV field 912 may include a primary ingress TLV, a backup ingress TLV, and/or a multicast flow specification TLV.

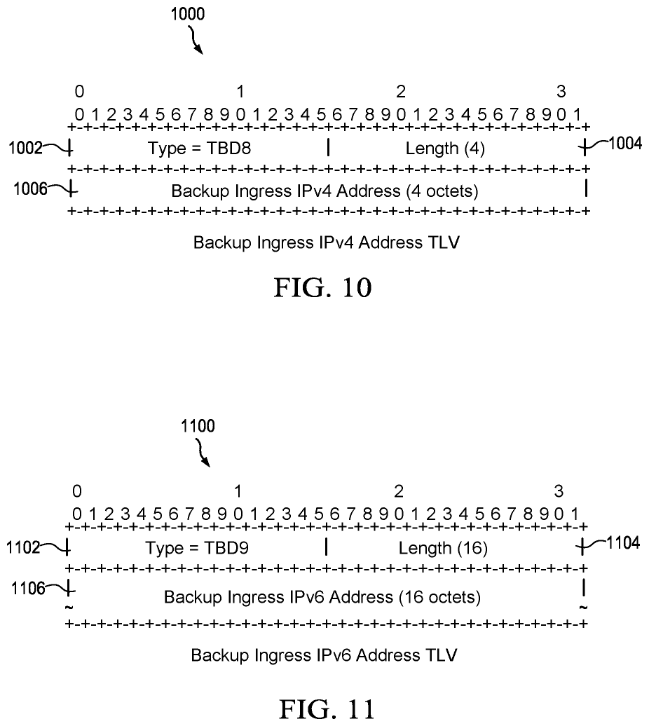

FIG. 10 is a schematic diagram of a Backup Ingress IPv4 Address TLV 1000 according to an embodiment of the disclosure. In an embodiment, the Backup Ingress IPv4 Address TLV 1000 is carried in the optional TLV field 912 of the BIER-TE-Path_Ingress-Protection Object Body 900.

The Backup Ingress IPv4 Address TLV 1000 comprises a type field 1002, a length field 1004, and a backup ingress IPv4 Address field 1006. The type field 1002 is 16 bits and the value in the type field 1002 is to be assigned by the IANA. The length field 1004 is 16 bits. In an embodiment, the value in the length field 1004 is 4 to indicate that the backup ingress IPv4 Address field 1006 is 32 bits. The backup ingress IPv4 Address field 1006 contains the IPv4 address of the backup ingress node. For example, the backup ingress IPv4 Address field 1006 may include the IPv4 address of network node 112 in FIG. 1.

FIG. 11 is a schematic diagram of a Backup Ingress IPv6 Address TLV 1100 according to an embodiment of the disclosure. In an embodiment, the Backup Ingress IPv6 Address TLV 1100 is carried in the optional TLV field 912 of the BIER-TE-Path_Ingress-Protection Object Body 900.

The Backup Ingress IPv6 Address TLV 1100 comprises a type field 1102, a length field 1104, and a backup ingress IPv6 Address field 1106. The type field 1102 is 16 bits and the value in the type field 1102 is to be assigned by the IANA. The length field 1104 is 16 bits. In an embodiment, the value in the length field 1104 is 16 to indicate that the backup ingress IPv6 Address field 1106 is 128 bits. The backup ingress IPv6 Address field 1106 contains the IPv6 address of the backup ingress node. For example, the backup ingress IPv6 Address field 1106 may include the IPv6 address of network node 112 in FIG. 1.

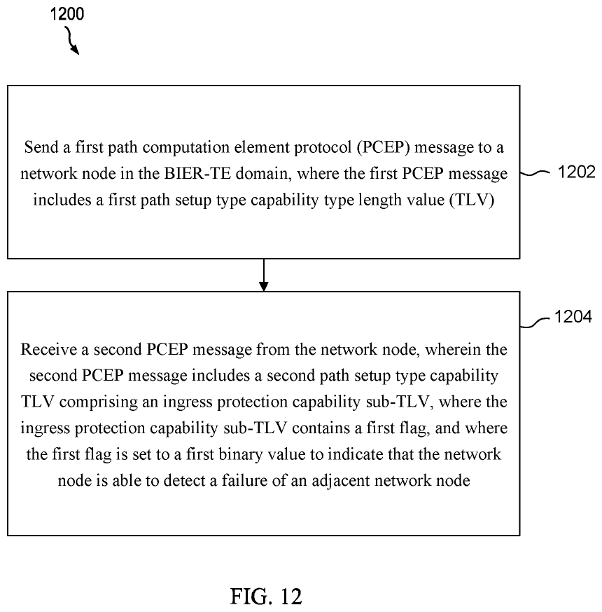

FIG. 12 is a method 1200 implemented by a network controller (e.g., network controller 130) configured to control the BIER-TE domain 102 according to an embodiment of the disclosure. The method 1200 may be performed by the network controller to establish ingress protection for a BIER-TE path from an ingress node to egress nodes.

In block 1202, the network controller sends a first path computation element protocol (PCEP) message to a network node in the BIER-TE domain. The first PCEP message includes a first path setup type capability TLV. In block 1204, the network controller receives a second PCEP message from the one or more network nodes. The second PCEP message includes a second path setup type capability TLV. The second path setup type capability TLV comprises an ingress protection capability sub-TLV containing a first flag. The first flag is set to a first binary value to indicate that the network node is able to detect a failure of an adjacent network node.

In an embodiment, the first PCEP message is an open message. The first path setup type capability TLV includes a first central controller (PCECC) sub-type length value (sub-TLV) containing a second flag. The second flag is set to the first binary value to indicate that the PCE supports and is willing to handle PCECC-based central controller instructions for ingress protection.

In an embodiment, the first path setup type capability TLV includes a path setup type (PST) containing a first value that indicates the path setup type capability TLV is for a BIER-TE path.

In an embodiment, the network node includes a backup ingress node of the BIER-TE domain or a customer edge (CE). The second PCEP message is an open message. The second path setup type capability TLV contains the first value.

In an embodiment, the second path setup type capability TLV contains a second central controller (PCECC) sub-type length value (sub-TLV) including a third flag. The third flag is set to the first binary value to indicate that the network node supports and is willing to handle PCECC-based central controller instructions for ingress protection.

In an embodiment, the method 1200 further comprises determining that the network node will be responsible for detecting the failure of the adjacent network node based on the first binary value of the first flag in the second PCEP message from the network node. That is, the method 1200 includes the PCE determining whether to implement the first case, the second case, or the third case described above.

In an embodiment, the network nodes comprises a backup ingress node, and the method 1200 further comprises sending a third PCEP message (e.g., a PCInitiate message) to the backup ingress node. The third PCEP message includes an ingress protection TLV containing: a fourth flag (e.g., the A flag) set to the first binary value to request that a forwarding entry for a backup BIER-TE path be active always; and a service sub-TLV including a service label or a service identifier. This embodiment corresponds to the first case described above.

In an embodiment, the network node comprises a backup ingress node, and the method 1200 further comprises sending a third PCEP message to the backup ingress node. The third PCEP message includes an ingress protection TLV. The ingress protection TLV contains a fourth flag (e.g., the A flag) set to a second binary value to request that the backup ingress node detect the failure of a primary ingress node and to let a forwarding entry for a backup BIER-TE path be active when the primary ingress node fails. The ingress protection TLV also contains service sub-TLV including a service label or a service identifier. The ingress protection TLV further contains primary ingress sub-TLV including a primary ingress address. This embodiment corresponds to the second case and the third case described above.

In an embodiment, the network node comprises a CE, and the method 1200 further comprises sending a fourth PCEP message (e.g., PCRpt, PCUpd, or PCInitiate message) to the CE. The fourth PCEP message includes an ingress protection object body containing a fifth flag (e.g., the D flag in the BIER-TE-Path_Ingress-Protection Object Body 900) and a sixth flag (e.g., the B flag). The fifth flag is set to the first binary value to instruct the CE to detect the failure of a primary ingress node and to switch traffic to a backup ingress node when the CE detects the failure. The sixth flag is set to a second binary value. This embodiment corresponds to the first case and the third case described above.

In an embodiment, the network node comprises a CE, and the method 1200 further comprises sending a fourth PCEP message to the CE. The fourth PCEP message includes an ingress protection object body containing a fifth flag and a sixth flag. The fifth flag is set to a second binary value, and the sixth flag is set to the first binary value to instruct the CE to send traffic to both a primary ingress node and a backup ingress node. This embodiment corresponds to the second case described above.

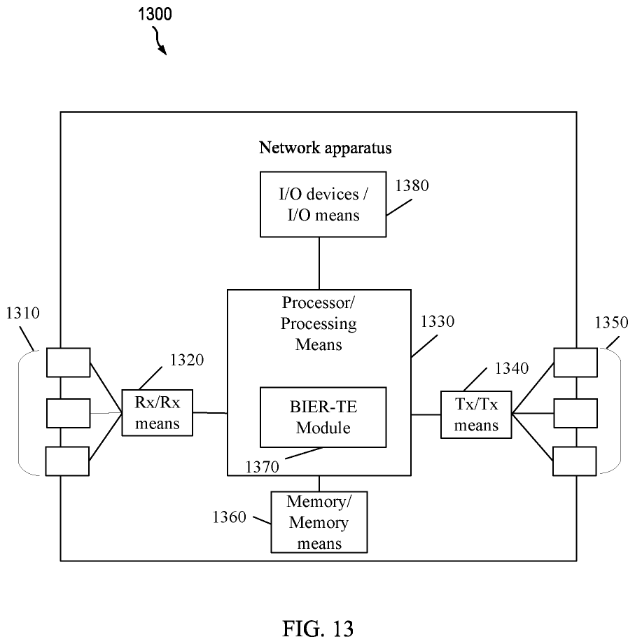

FIG. 13 is a schematic diagram of a network apparatus 1300 (e.g., a network controller, a network node, etc.). The network apparatus 1300 is suitable for implementing the disclosed embodiments as described herein. The network apparatus 1300 comprises ingress ports/ingress means 1310 (a.k.a., upstream ports) and receiver units (Rx)/receiving means 1320 for receiving data; a processor, logic unit, or central processing unit (CPU)/processing means 1330 to process the data; transmitter units (Tx)/transmitting means 1340 and egress ports/egress means 1350 (a.k.a., downstream ports) for transmitting the data; and a memory/memory means 1360 for storing the data. The network apparatus 1300 may also comprise optical-to-electrical (OE) components and electrical-to-optical (EO) components coupled to the ingress ports/ingress means 1310, the receiver units/receiving means 1320, the transmitter units/transmitting means 1340, and the egress ports/egress means 1350 for egress or ingress of optical or electrical signals.

The processor/processing means 1330 is implemented by hardware and software. The processor/processing means 1330 may be implemented as one or more CPU chips, cores (e.g., as a multi-core processor), field-programmable gate arrays (FPGAs), application specific integrated circuits (ASICs), and digital signal processors (DSPs). The processor/processing means 1330 is in communication with the ingress ports/ingress means 1310, receiver units/receiving means 1320, transmitter units/transmitting means 1340, egress ports/egress means 1350, and memory/memory means 1360. The processor/processing means 1330 comprises a BIER-TE module 1370. The BIER-TE module 1370 is able to implement the methods disclosed herein. The inclusion of the BIER-TE module 1370 therefore provides a substantial improvement to the functionality of the network apparatus 1300 and effects a transformation of the network apparatus 1300 to a different state. Alternatively, the BIER-TE module 1370 is implemented as instructions stored in the memory/memory means 1360 and executed by the processor/processing means 1330.

The network apparatus 1300 may also include input and/or output (I/O) devices or I/O means 1380 for communicating data to and from a user. The I/O devices or I/O means 1380 may include output devices such as a display for displaying video data, speakers for outputting audio data, etc. The I/O devices or I/O means 1380 may also include input devices, such as a keyboard, mouse, trackball, etc., and/or corresponding interfaces for interacting with such output devices.

The memory/memory means 1360 comprises one or more disks, tape drives, and solid-state drives and may be used as an over-flow data storage device, to store programs when such programs are selected for execution, and to store instructions and data that are read during program execution. The memory/memory means 1360 may be volatile and/or non-volatile and may be read-only memory (ROM), random access memory (RAM), ternary content-addressable memory (TCAM), and/or static random-access memory (SRAM).

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented by a path computation element (PCE) configured to control a Bit Index Explicit Replication Traffic/Tree Engineering (BIER-TE) domain, comprising:
sending a first path computation element protocol (PCEP) message to a network node in the BIER-TE domain, wherein the first PCEP message includes a first path setup type capability type length value (TLV); and
receiving a second PCEP message from the network node, wherein the second PCEP message includes a second path setup type capability TLV comprising an ingress protection capability sub-TLV, wherein the ingress protection capability sub-TLV contains a first flag, and wherein the first flag is set to a first binary value to indicate that the network node is able to detect a failure of an adjacent network node.

2. The method of claim 1, wherein the first PCEP message is an open message, and wherein the first path setup type capability TLV includes a first central controller (PCECC) sub-type length value (sub-TLV) containing a second flag, and wherein the second flag is set to the first binary value to indicate that the PCE supports and is willing to handle PCECC-based central controller instructions for ingress protection.

3. The method of claim 1, wherein the first path setup type capability TLV includes a path setup type (PST) containing the first binary value that indicates the first path setup type capability TLV is for a BIER-TE path.

4. The method of claim 3, wherein the network node comprises a backup ingress node in the BIER-TE domain or a customer edge (CE), and wherein the second PCEP message is an open message, and wherein the second path setup type capability TLV contains the first binary value.

5. The method of claim 1, wherein the second path setup type capability TLV contains a second central controller (PCECC) sub-type length value (sub-TLV) including a third flag, and wherein the third flag is set to the first binary value to indicate that the network node supports and is willing to handle PCECC-based central controller instructions for ingress protection.

6. The method of claim 1, further comprising determining that the network node will be responsible for detecting the failure of the adjacent network node based on the first binary value of the first flag in the second PCEP message from the network node.

7. The method of claim 1, wherein the network node comprises a backup ingress node in the BIER-TE domain, and wherein the method further comprises sending a third PCEP message to the backup ingress node, wherein the third PCEP message includes an ingress protection TLV containing:
a fourth flag set to the first binary value to request that a forwarding entry for a backup BIER-TE path be active always; and
a service sub-TLV including a service label or a service identifier.

8. The method of claim 1, wherein the network node comprises a backup ingress node in the BIER-TE domain, and wherein the method further comprises sending a third PCEP message to the backup ingress node, wherein the third PCEP message includes an ingress protection TLV containing:
a fourth flag set to a second binary value to request that the backup ingress node detect the failure of a primary ingress node and to let a forwarding entry for a backup BIER-TE path be active when the primary ingress node fails;
a service sub-TLV including a service label or a service identifier; and
a primary ingress sub-TLV including a primary ingress address.

9. The method of claim 1, wherein the network node comprises a customer edge (CE), and wherein the method further comprises sending a fourth PCEP message to the CE, wherein the fourth PCEP message includes an ingress protection object body containing a fifth flag and a sixth flag, wherein the fifth flag is set to the first binary value to instruct the CE to detect the failure of a primary ingress node and to switch traffic to a backup ingress node when the CE detects the failure, and wherein the sixth flag is set to a second binary value.

10. The method of claim 1, wherein the network node comprises a customer edge (CE), and wherein the method further comprises sending a fourth PCEP message to the CE, wherein the fourth PCEP message includes an ingress protection object body containing a fifth flag and a sixth flag, wherein the fifth flag is set to a second binary value, and wherein the sixth flag is set to the first binary value to instruct the CE to send traffic to both a primary ingress node and a backup ingress node.

11. A path computation element (PCE) configured to control a Bit Index Explicit Replication Traffic/Tree Engineering (BIER-TE) domain, comprising:
a memory storing instructions;
one or more processors coupled to the memory, wherein the one or more processors are configured to execute the instructions to cause the PCE to:
send a first path computation element protocol (PCEP) message to a network node in the BIER-TE domain, wherein the first PCEP message includes a first path setup type capability type length value (TLV); and
receive a second PCEP message from the network node, wherein the second PCEP message includes a second path setup type capability TLV comprising an ingress protection capability sub-TLV, wherein the ingress protection capability sub-TLV contains a first flag, and wherein the first flag is set to a first binary value to indicate that the network node is able to detect a failure of an adjacent network node.

12. The PCE of claim 11, wherein the first PCEP message is an open message, wherein the first path setup type capability TLV of the open message includes a path setup type (PST) containing a first value that indicates the first path setup type capability TLV is for a BIER-TE path.

13. The PCE of claim 11, wherein the first path setup type capability TLV includes a first central controller (PCECC) sub-type length value (sub-TLV) containing a second flag, and wherein the second flag is set to the first binary value to indicate that the PCE supports and is willing to handle PCECC-based central controller instructions for ingress protection.

14. The PCE of claim 11, wherein the network node comprises a backup ingress node in the BIER-TE domain or a customer edge (CE), and wherein the second PCEP message is an open message, and wherein the second path setup type capability TLV contains the first binary value.

15. The PCE of claim 11, wherein the second path setup type capability TLV contains a second central controller (PCECC) sub-type length value (sub-TLV) including a third flag, and wherein the third flag is set to the first binary value to indicate that the network node supports and is willing to handle PCECC-based central controller instructions for ingress protection.

16. The PCE of claim 11, wherein the one or more processors are further configured to determine that the network node will be responsible for detecting the failure of the adjacent network node based on the first binary value of the first flag in the second PCEP message from the network node.

17. The PCE of claim 11, wherein the network node comprises a backup ingress node, and wherein the one or more processors are further configured to send a third PCEP message to the backup ingress node, wherein the third PCEP message includes an ingress protection TLV containing:
a fourth flag set to the first binary value to request that a forwarding entry for a backup BIER-TE path be active always; and
a service sub-TLV including a service label or a service identifier.

18. The PCE of claim 11, wherein the network node comprises a backup ingress node, and wherein the one or more processors are further configured to send a third PCEP message to the backup ingress node, wherein the third PCEP message includes an ingress protection TLV containing:
a fourth flag set to a second binary value to request that the backup ingress node detect the failure of a primary ingress node and to let a forwarding entry for a backup BIER-TE path be active when the primary ingress node fails;
a service sub-TLV including a service label or a service identifier; and
a primary ingress sub-TLV including a primary ingress address.

19. The PCE of claim 11, wherein the network node comprises a customer edge (CE), and wherein the one or more processors are further configured to send a fourth PCEP message to the CE, wherein the fourth PCEP message includes an ingress protection object body containing a fifth flag and a sixth flag, wherein the fifth flag is set to the first binary value to instruct the CE to detect the failure of a primary ingress node and to switch traffic to a backup ingress node when the CE detects the failure, and wherein the sixth flag is set to a second binary value.

20. The PCE of claim 11, wherein the network node comprises a customer edge (CE), and wherein the one or more processors are further configured to send a fourth PCEP message to the CE, wherein the fourth PCEP message includes an ingress protection object body containing a fifth flag and a sixth flag, wherein the fifth flag is set to a second binary value, and wherein the sixth flag is set to the first binary value to instruct the CE to send traffic to both a primary ingress node and a backup ingress node.

21. A non-transitory computer readable medium comprising a computer program product for use by a network node, the computer program product comprising computer executable instructions stored on the non-transitory computer readable medium that, when executed by one or more processors, cause the network node to:
send a first path computation element protocol (PCEP) message to the network node in a Bit Index Explicit Replication Traffic/Tree Engineering (BIER-TE) domain, wherein the first PCEP message includes a first path setup type capability type length value (TLV); and
receive a second PCEP message from the network node, wherein the second PCEP message includes a second path setup type capability TLV comprising an ingress protection capability sub-TLV, wherein the ingress protection capability sub-TLV contains a first flag, and wherein the first flag is set to a first binary value to indicate that the network node is able to detect a failure of an adjacent network node.

22. The non-transitory computer readable medium of claim 21, wherein the instructions further cause the network node to determine that the network node will be responsible for detecting the failure of the adjacent network node based on the first binary value of the first flag in the second PCEP message from the network node.

23. The non-transitory computer readable medium of claim 21, wherein the network node comprises a backup ingress node, and wherein the instructions further cause the network node to send a third PCEP message to the backup ingress node, wherein the third PCEP message includes an ingress protection TLV containing:
a fourth flag set to the first binary value to request that a forwarding entry for a backup BIER-TE path be active always; and
a service sub-TLV including a service label or a service identifier.

24. The non-transitory computer readable medium of claim 21, wherein the network node comprises a backup ingress node, and wherein the instructions further cause the network node to send a third PCEP message to the backup ingress node, wherein the third PCEP message includes an ingress protection TLV containing:
a fourth flag set to a second binary value to request that the backup ingress node detect the failure of a primary ingress node and to let a forwarding entry for a backup BIER-TE path be active when the primary ingress node fails;
a service sub-TLV including a service label or a service identifier; and
a primary ingress sub-TLV including a primary ingress address.

25. The non-transitory computer readable medium of claim 21, wherein the network node comprises a customer edge (CE), and wherein the instructions further cause the network node to send a fourth PCEP message to the CE, wherein the fourth PCEP message includes an ingress protection object body containing a fifth flag and a sixth flag, wherein the fifth flag is set to the first binary value to instruct the CE to detect the failure of a primary ingress node and to switch traffic to a backup ingress node when the CE detects the failure, and wherein the sixth flag is set to a second binary value.

26. The non-transitory computer readable medium of claim 21, wherein the network node includes a customer edge (CE), and wherein the instructions further cause the network node to send a fourth PCEP message to the CE, wherein the fourth PCEP message includes an ingress protection object body containing a fifth flag and a sixth flag, wherein the fifth flag is set to a second binary value, and wherein the sixth flag is set to the first binary value to instruct the CE to send traffic to both a primary ingress node and a backup ingress node.
